(19) United States
(12) Patent Application Publication
(10) Pub. No.: US 2022/0000298 A1
(43) Pub. Date: Jan. 6, 2022

(54) COOKWARE WITH ELECTRONIC DISPLAY

(71) Applicant: Zega Holdings Pty Ltd, Sydney, New South Wales (AU)

(72) Inventors: Brendan Dunne, Hong Kong (CN); Brian Mooney, New South Wales (AU); Cornelius Dunne, Victoria (AU); Tom Pearce, London (GB)

(73) Assignee: Zega Holdings Pty Ltd, Sydney, New South Wales (AU)

(21) Appl. No.: 17/284,313

(22) PCT Filed: Oct. 2, 2019
(86) PCT No.: PCT/AU2019/051071

§ 371 Date: Apr. 9, 2021

(30) Foreign Application Priority Data
Oct. 12, 2018 (HK) 18113121.5
Jan. 16, 2019 (HK) 19100744.8

(51) Int. Cl. A47J 27/00; A47J 36/06; A47J 36/32

(52) U.S. Cl. CPC A47J 27/002; A47J 2202/00; A47J 36/321; A47J 36/06

(57) ABSTRACT

According to a first aspect of the present invention, there is provided a cookware comprising a double wall cooking apparatus having a mounted electronic device, the mounted electronic device comprising a processor and an electronic display, wherein the processor is programmed with instructions that, when executed, cause the processor at least to configure the electronic display to indicate a status of the double wall cooking apparatus. The cookware may further comprise a temperature sensor and/or a wireless transceiver, wherein the temperature sensor is calibrated to read an internal temperature of the double wall cooking apparatus; and wherein the wireless transceiver detects commands from the processor to provide content for display on the electronic display.

### FIELD

The present invention relates to cookware with an electronic display that assists to monitor cooking.

### BACKGROUND

Cooking apparatus comes in various configurations, such as pots and pans. Some use single wall structures, while others double wall structures, depending on the cooking requirement.

When using such apparatus on stoves or hobs, cooking has to be continuously monitored, to ensure that a correct amount of heat is used and a duration over it is applied. Even when following recipes that indicate a size of the heat to be used, ensuring that the correct amount of heat is at times through a best estimate. This continuous monitoring makes cooking time consuming.

An object of the present invention is to provide cookware that addresses the above limitations.

### SUMMARY OF THE INVENTION

According to one aspect of the present invention, there is provided a cookware comprising a double wall cooking apparatus having a mounted electronic device, the mounted electronic device comprising a processor; and an electronic display, wherein the processor is programmed with instructions that, when executed, cause the processor at least to configure the electronic display to indicate a status of the double wall cooking apparatus.

According to a further aspect of the invention, there is provided a cookware mounted electronic device comprising: a processor; and an electronic display, wherein the processor is programmed with instructions that, when executed, cause the processor at least to: configure the electronic display to indicate a status of a cooking apparatus to which the electronic device is mounted.

According to another aspect of the invention, there is provided a non-transitory computer-readable medium, with instructions stored thereon, which when executed by at least one processor of at least one computing device cause the at least one computing device to receive a selected recipe from a database of stored recipes; determine a heating cooking duration and a self-cooking cooking duration for the selected recipe; and display a countdown for the heating cooking duration and the self-cooking cooking duration, wherein the countdown is initialised in response to receipt of an input to commence cooking.

### BRIEF DESCRIPTION OF THE DRAWINGS

Representative embodiments of the present invention are herein described, by way of example only, with reference to the accompanying drawings, wherein:

FIG. 1 is a schematic of a cookware having a cooking apparatus and a mounted electronic device, in accordance with one embodiment of the present invention.

FIGS. 2 to 4 show various pages of an application operating in a remote computing device, the application being configured to communicate with the electronic device of FIG. 1.

FIG. 5 shows the display of the remote computing device and an electronic display of the electronic device of FIG. 1 in a heating mode.

FIG. 6 shows the display of the remote computing device and an electronic display of the electronic device of FIG. 1 in a self-cooking mode.

FIG. 7 provides a perspective view of a cookware in accordance with one implementation of the present invention.

FIG. 8 shows a partial cross-sectional view of a vessel of the cookware of FIG. 7.

FIG. 9 shows a bottom view of a lid of the cookware of FIG. 7.

FIG. 10 shows a perspective view of a rack and trivet of the cookware of FIG. 7.

FIG. 11 shows top and bottom views of a tray of the cookware of FIG. 7.

### DETAILED DESCRIPTION

In the following description, various embodiments are described with reference to the drawings, where like reference characters generally refer to the same parts throughout the different views.

The present application, in a broad overview, relates to an electronic device designed for use with a cooking apparatus. In this disclosure, the term “cookware” is used to refer to a combination of the electronic device mounted on the cooking apparatus. As such, cookware excludes reference to a heat source (electrical or gas) for the cooking apparatus, e.g.: a gas stove, an induction stove, a gas hob, an induction hob or an oven.

The cooking apparatus refers to a container, such as a pot or a pan, used on gas or induction stoves/hobs. The electronic device refers to an accessory that is fixed to the cooking apparatus, the accessory having electronic components which include an electronic display that serves to provide a visual indicator of a status of the cooking apparatus. In implementations where a reading of an internal temperature is available, the status refers to interior conditions of the cooking apparatus due to this internal temperature, such as its value at any point, (e.g: room temperature, 45° C., 90° C.), a rate in which the internal temperature increases, a duration over which the internal temperature remains constant or a rate in which the internal temperature decreases; all from which conclusions can be drawn regarding cooking progress of content within the cooking apparatus, like a cooking stage at an instance. In implementations where the electronic display can be remotely controlled, the status of the cooking apparatus then depends on commands received from such remote control. In implementations where both the reading of the internal temperature is available and the electronic display can be remotely controlled, the status of the cooking apparatus is determined by both the interior conditions of the cooking apparatus and the commands received from the remote control. Thus parameters having an impact on the status of the cooking apparatus, which in turn changes the content shown by the electronic display, include a temperature reading within the cooking apparatus, an externally received command or both.

The indication of the status of the cooking apparatus refers to use of one or more of text, numerals, icons, symbols, animation, to convey a message about the status of the cooking apparatus. The message can be just plain characters (e.g. a combination of text or numerals to express self-explanatory content “cooking complete”, the internal temperature is “90° C.”, a heating duration of “10 mins”) or graphic (e.g. icon, symbol, animation) whose associated significance or meaning may be found from an instruction manual accompanying the cookware (e.g. an animation directing for ingredients to be placed into the cooking apparatus).

Advantageously, the electronic device facilitates monitoring of cooking which has several stages, such as thermal cooking, a process where in a first stage the cooking apparatus is heated to a desired temperature (called “heating mode”), while in a second stage the heat source is turned off and the content allowed to cook from the residual heat (called “self-cooking mode”). The electronic device can also facilitate adherence to steps of a cooking recipe, these steps being communicated from a remote computing device. In addition, through such communication, cooking can also be monitored using the remote computing device. The cooking apparatus and its mounted electronic device are described in greater detail below.

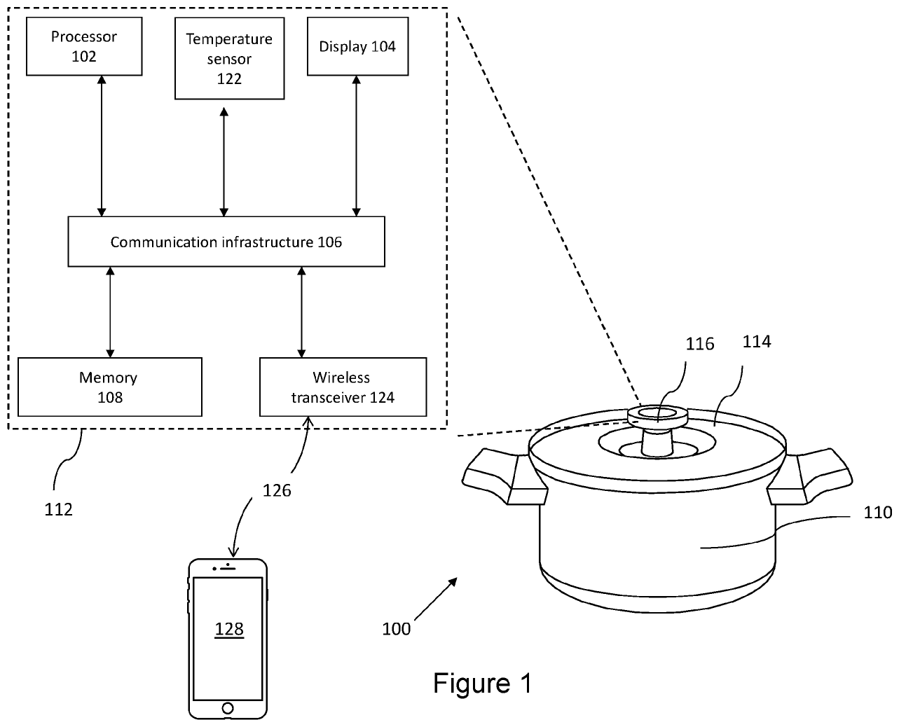

FIG. 1 is a schematic of a cookware 100 having a cooking apparatus 110 and a mounted electronic device 112. The cooking apparatus 110 has a single wall structure, although a double wall structure is possible, such as for thermal cooking applications.

For the sake of simplicity, only selected electronic components of the electronic device 112 are shown in FIG. 1. Other components such as a power source, along with those that the skilled person would understand are required, are omitted. The electronic device 112 has a processor 102 programmed with instructions that, when executed, cause the processor 102 to configure an electronic display 104 to indicate a status of the cooking apparatus 110. In one implementation, such programming means that the processor 102 is designed with circuitry that executes instructions to indicate the status of the cooking apparatus 110. In another implementation, memory 108 stores instructions that when executed program the processor 102 to indicate the status of the cooking apparatus 110. To provide this status, the processor 102 sends commands, over communication infrastructure 106, with all components (such as a temperature sensor 122, a wireless transceiver 124, the electronic display 104 and the memory 108) of the electronic device 112. The communication infrastructure 106 refers to data communication channels such as a bus.

While FIG. 1 shows that the electronic device 112 has both a temperature sensor 122 and a wireless transceiver 124, it will be appreciated that either may be absent, depending on the requirement of the cooking apparatus 110. That is, in a first implementation, only the temperature sensor 122 is present; in a second implementation, only the wireless transceiver 124 is present; and in a third implementation, both the temperature sensor 122 and the wireless transceiver 124 are present.

The temperature sensor 122 is calibrated to read an internal temperature of the cooking apparatus 110, which provides a gauge of the temperature of content placed inside the cooking apparatus 110. The temperature sensor 122 may be a contact based module, e.g. a thermistor, a resistance temperature detector, a thermocouple, a semiconductor-based sensor; or a non-contact based module, such as an infrared detector. In one implementation, where the cooking apparatus 110 has a double wall structure, the temperature sensor 122 may be placed in the space between the double wall structure. In another implementation, where the electronic device is integrated with a handle 116 of a lid 114 of the cooking apparatus 110, the temperature sensor 122 may be placed at an interface between the handle 116 and the lid 114. The temperature sensor 122 is calibrated so as to obtain an accurate reading of the internal temperature, whereby adjustments are made to account for its specific location on the cooking apparatus 110 and the module used for the temperature sensor 122. A reading from the temperature sensor 122 can be obtained when the cooking apparatus 110 is in a feedback mode status.

The wireless transceiver 124 allows the electronic device 112 to communicate 126 with remote computing devices 128, such as a specifically designed application operating on a smart phone. The wireless transceiver 124 may be part of electronics on a circuit board that allows the electronic device 112 to have Internet connectivity and IoT (Internet of Things) capability, whereby the wireless transceiver 124 provides a means for the processor 102 to collect and exchange data (such as with the specifically designed application operating in the remote computing device 128) that impacts the status of the cooking apparatus 110 and consequently the content shown in the electronic display 104. The wireless transceiver 124 may have Wi-Fi capability, whereby communication with an application operating in the remote computing device 128 first routes through a Wi-Fi network in which the electronic device 112 belongs, followed by a cellular network servicing the remote computing device 128, so that the remote computing device 128 does not need to be in proximity with the wireless transceiver 124 to communicate with the processor 102. Alternatively, the wireless transceiver 124 may be a Bluetooth device which pairs with an application operating in the remote computing device 128 for proximity communication. It is also possible for the wireless transceiver 124 to have both Wi-Fi and Bluetooth capability.

Examples of applications operating on the remote computing device 128 include recipes that are tailored for cooking that is envisaged with the cooking apparatus 110 and the specific electronic device 112 configuration (such as whether it also has a temperature sensor 122). The recipe may be communicated to the processor 102 over the wireless transceiver 124, whereby the processor 102 then changes the content of the electronic display 104 to reflect the status of the cooking apparatus 110 as being in which stage of the recipe sequence. Accordingly, the wireless transceiver 124 allows the cookware 100 to become part of a smart home network, since the status of the cooking apparatus 110 can be monitored from the remote computing device 128.

The content shown on the electronic display 104 depends on the specific implementation of the electronic device 112. This is because different data parameters are available in each of the at least three implementations described above, from which the processor 102 uses to determine the content shown in the electronic display 104, to provide a status of the cooking apparatus 110. When the temperature sensor 122 is present, the processor 102 obtains a reading from the temperature sensor 122, from which the status of the cooking apparatus 110 is derived. When the wireless transceiver 124 is present, the processor 102 detects for receipt, by the wireless transceiver 124, of a command providing content for display by the electronic display 104 and derives the status of the cooking apparatus 110 from the received command When both the temperature sensor 122 and the wireless transceiver 124 are present, the processor 102 derives the status of the cooking apparatus 110 from a reading of the internal temperature of the cooking apparatus 110 and the command received from the wireless transceiver 124.

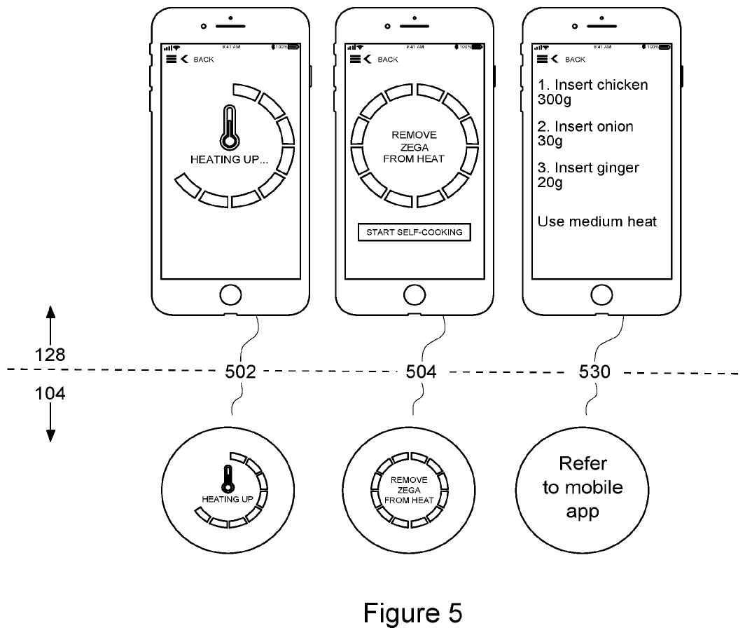

In addition to serving as a display to show the status of the cooking apparatus 110, the electronic display 104 may also be a touch-sensitive screen and serves as an input means for the electronic device 112. The input that the electronic display 104 is configured to accept depends on the status of the cooking apparatus 110 at an instance. With reference to FIG. 5, if the cooking apparatus 110 is to be removed from a heat source, the electronic display 104, contacting the electronic display 104 will serve as an indicator to the processor 102 that the cooking apparatus 110 is removed from the heat source.

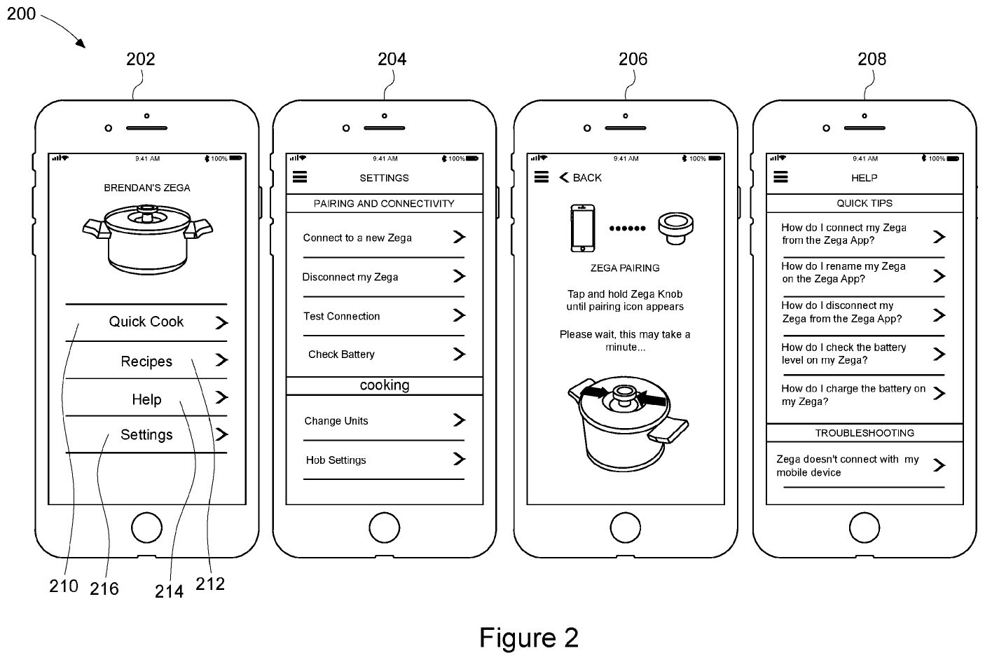

FIGS. 2 to 4 show various pages of an application 200 operating in the remote computing device 128 of FIG. 1, the application 200 being configured to communicate 126 with the electronic device 112 through its wireless transceiver 124. While a smart phone is shown in FIGS. 2 to 4, it will be appreciated that the remote computing device 128 may be any external computing device that runs a similar application as that shown in FIGS. 2 to 4.

Referring to FIG. 2, a home page 202 provides access to all features of the application 200 through touch buttons 210, 212, 214 and 216. The settings button 216 allows registration of the electronic device 112 into the application 200, by providing means to store a unique identification number of the electronic device 112 into the application 200. In more detail, through the settings button 216, the application 200 guides a user to configure the remote computing device 128 to pair (e.g. using Bluetooth) with the electronic device 112 through providing appropriate options on settings page 204 and upon selection of an option, listing the steps that need to be undertaken on an instructions page 206. While only pairing is shown in the page 206, it will be appreciated that the settings button 216 also allows for the application 200 to configure the remote computing device 128 to identify the electronic display 104 over cellular and Wi-Fi networks, as earlier mentioned. The help button 214 provides instruction manual type of information, such as troubleshooting tips and guidance on changing a battery in the electronic device 112, on a help page 208.

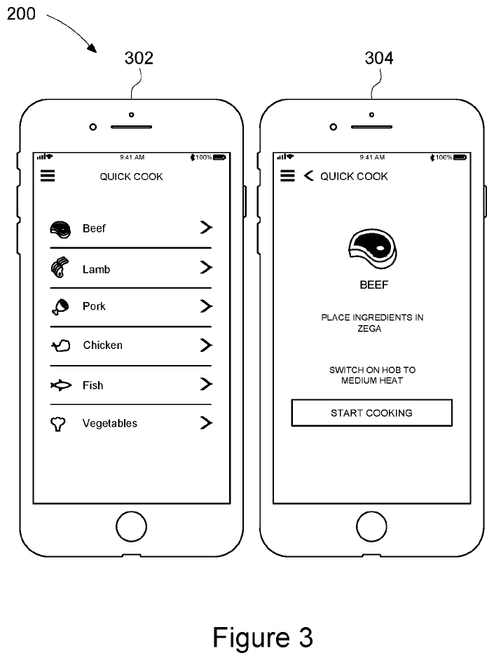

The application 200 keeps cooking settings under two categories, each accessible by the quick cook button 210 (for simple cooking) and the recipes button 212 (for cooking a specific dish). Selecting the quick cook button 210 brings a user to pages 302 and 304, as shown in FIG. 3. Selection of a food category (e.g. beef, chicken, vegetables) in the page 302 causes the application 200 to prompt for the user to place ingredients into the cooking apparatus 110 at page 304 and retrieves a stored optimal cooking timing for a displayed heat setting. A medium heat setting is shown on page 304, where it will be appreciated that another optimal cooking time is calculated should a dish require another heat setting. After the ingredients are placed into the cooking apparatus 110 and a hob or stove on which the cooking apparatus 110 is placed is set to medium heat, monitoring of the cooking can start by pressing the “start cooking” button shown on page 304 or on the electronic display 104 of the electronic device 112. The optimal cooking time is then transmitted to the electronic device 112 through its wireless transceiver 124 when the user selects for cooking to start.

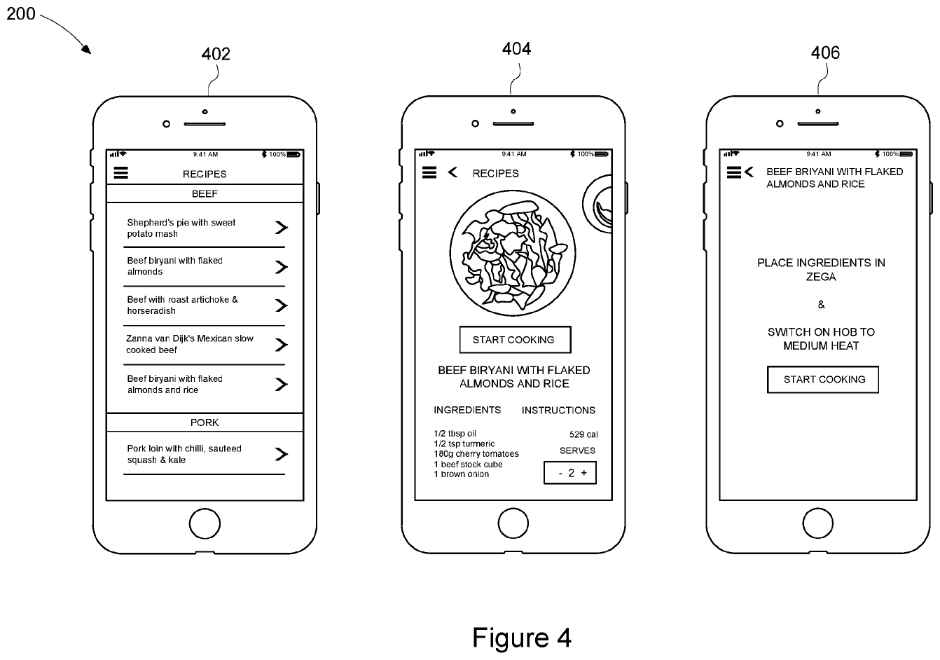

Selecting the recipes button 212 brings a user to page 402 which provides a list of stored recipes, organised into categories (e.g. beef, chicken), as shown in FIG. 4. Selection of a recipe brings a user to page 404, which lists the ingredients needed to create the specific dish. The application 200 may be configured to adjust the amount of ingredients needed in response to the number of servings that are to be made. Similar to the quick cook button 210, the application 200 prompts for the user to place ingredients into the cooking apparatus 110 at page 406 and retrieves a stored optimal cooking timing. The optimal cooking time is then transmitted to the electronic device 112 through its wireless transceiver 124 when the user selects for cooking to start.

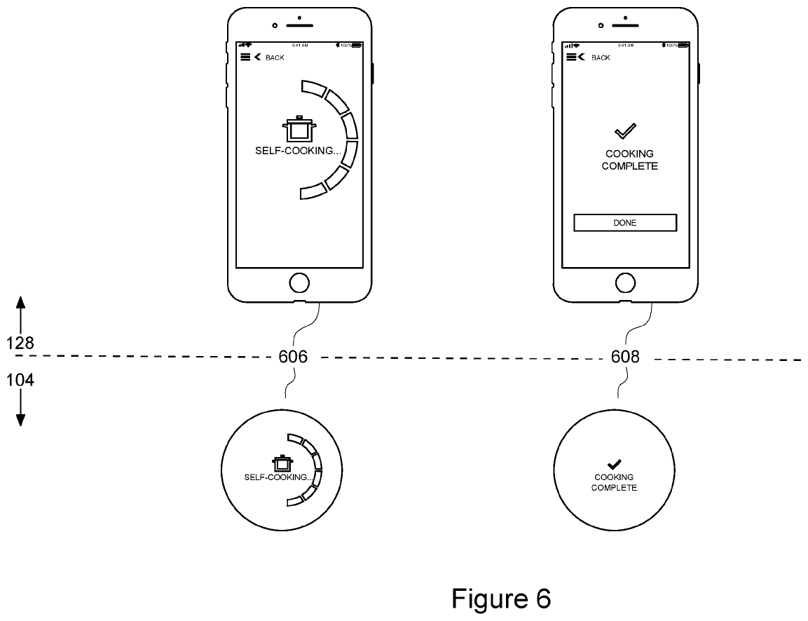

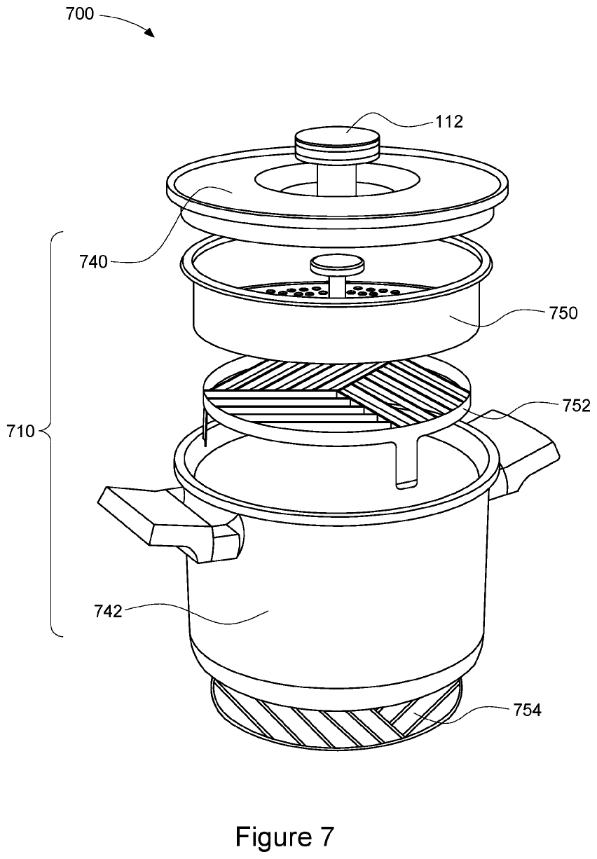

Each of the quick cook button 210 or the recipes button 212 categories has a database of choices, with each choice having automatically configured thermal cooking settings. That is, when one of the choices is selected, the application 200 determines a corresponding heating cooking duration and a self-cooking cooking duration which are both transmitted to the processor 102 of the electronic device 112 via its wireless transceiver 124. This will lead to display of a countdown for the heating cooking duration and the self-cooking cooking duration, described in more detail below with respect to FIGS. 6 and 7.

Referring to FIGS. 1 to 4, the content of the electronic display 104 may change to synchronise with the content that is being displayed by the remote computing device 128. For instance, when the remote computing device 128 is registering the electronic device 112, as shown in on the page 206, the processor 102 causes the electronic display 104 to show the status of the cooking apparatus 110 as being onboarded. While the application 200 in the remote computing device 128 is at the quick cook pages 302, 304 or recipes pages 402, 404 and 406, the processor 102 causes the electronic display 104 to show the status of the cooking apparatus 110 as being in a prompt mode, where guidance is being given to a user to perform cooking, the content of the electronic display 104 being a condensed version of that displayed by the application (e.g. for the page 402, the electronic display 104 may show “select recipe; for the page 404, the electronic display 104 may show abbreviations for the required ingredients, “BF” for “beef”; “CHK” for “chicken”; and for the page 406, the electronic display 104 may show “use medium heat”).

When the electronic device 112 is implemented without the temperature sensor 122, the cooking timings that are shown on the electronic display 104 will be as per those stored in the application 200 under the quick cook pages 302, 304 and the recipes pages 402, 404 and 406. These cooking timings will be provided through a command transmitted by the remote computing device 128 and received by the wireless transceiver 124. The processor 102 then controls the electronic display 104 to show a visual representation of the received cooking timing. When the electronic device 112 is implemented with the temperature sensor 122, the processor 102 analyses both the received cooking timing and the internal temperature of the cooking apparatus 110 using an appropriate algorithm written into the memory 108. If the result of the analysis indicates that the received cooking timing is too long or too short to perform cooking, the cooking timing is adjusted accordingly. The processor 102 controls the electronic display 104 to show a visual representation of the revised cooking timing and also communicates 126 the revised cooking timing to the remote computing device 128 via the wireless transceiver 124, so that the application 200 also monitors the revised cooking timing (rather than the original stored cooking timing). Accordingly, in both implementations (i.e. with or without the temperature sensor 122), both the electronic display 104 of the electronic device 112 and the remote computing device 128 show the same cooking timing.

FIG. 5 shows the display of the remote computing device 128 and the electronic display 104 of the electronic device 112 when the cooking apparatus 110 is in a heating mode 502. This heating mode 502 is a first stage in thermal cooking, where the cooking apparatus 110 is heated to a desired temperature. With reference to FIGS. 3 and 4, the heating mode 502 is entered after a user indicates for cooking to start from the quick cook pages 302, 304; or to start from the recipes pages 402, 404 and 406, where the wireless transceiver 124 receives instructions from the remote computing device 128 that provides a heating cooking duration. Alternatively, the heating mode 502 can also be entered from a menu accessible through the touch-sensitive input of the electronic display 104, where the progress of the heating mode 502 depends on the internal temperature of the cooking apparatus 110 measured by the temperature sensor 122.

At the end of the heating mode 502, the display of the remote computing device 128 and the electronic display 104 of the electronic device 112 will show the status of the cooking apparatus 110 as being in an alert mode 504. The alert mode 504 requires intervention, whereby the processor 102 sends a notification (such as a sound or an attention catching symbol) requiring acknowledgment and configures the electronic display 104 to provide a sought input. In the case of sound, it can emitted from a speaker of the electronic device 112 or the processor 102 can trigger, through the wireless transceiver 124, the remote computing device 128 to issue the sound. The electronic display 104, the display of the remote computing device 128, or both can show text, such as “remove the cooking apparatus 110 from heat”, to guide a user on the sought input. While the heating mode 502 and the alert mode 504 show the same content in FIG. 5, the synchronisation of the display of the remote computing device 128 and the electronic display 104 of the electronic device 112 does not necessarily require that both displays show the same content. As mentioned above, the electronic display 104 may show abbreviations of the content of the display of the remote computing device 128. In one implementation of a prompt mode 530, the electronic device 112 may direct a user to refer to the display of the remote computing device 128 for what needs to be done, e.g. ingredients that are to be placed into the cooking apparatus 110 and a heat setting for the hob or stove on which the cooking apparatus 110 is placed.

FIG. 6 shows the display of the remote computing device 128 and the electronic display 104 of the electronic device 112 when the cooking apparatus 110 is in a self-cooking mode 606. This self-cooking mode 606 is a second stage in thermal cooking, where cooking occurs from residual heat from the end of the heating mode 502. The wireless transceiver 124 may receive instructions that provide a self-cooking cooking duration. Alternatively, the self-cooking mode 606 can also be entered from a menu accessible through the touch-sensitive input of the electronic display 104 after the end of the heating mode 502, where the progress of the self-cooking mode 606 depends on the internal temperature of the cooking apparatus 110 measured by the temperature sensor 122.

From FIGS. 5 and 6, it can be seen that the processor 102 (confer FIG. 1) displays the heating cooking duration in the heating mode 502 and the self-cooking cooking duration in the self-cooking mode 606 as separate countdown timers. While a segmented time bar is shown in FIGS. 6 and 7, other visual representations are possible, such as providing a numerical countdown before the end of the respective heating mode 502 and the self-cooking mode 606.

In the implementation shown in FIGS. 5 and 6, the processor 102 configures the electronic display 104 to replace the heating countdown timer with the self-counting countdown timer after the heating cooking duration has passed. Further, the self-cooking mode 606 only displays in response to the processor 102 receiving an acknowledgement of the heating mode 502 having been concluded. In another implementation (not shown), both the heating mode countdown and the self-cooking mode countdown are shown simultaneously, with the self-cooking mode countdown only commencing after the heating mode countdown has concluded.

After the self-cooking mode 606 ends, the display of the remote computing device 128 and the electronic display 104 of the electronic device 112 will show the status of the cooking apparatus 110 as being in a complete mode 608, where a message will display indicating that cooking has completed.

FIG. 7 provides a perspective view of a cookware 700 in accordance with one implementation of the present invention. Similar to FIG. 1, the cookware 700 has a cooking apparatus 710 having a mounted electronic device 112. The electronic device 112 is similar to the one in FIG. 1, where in a first implementation only the temperature sensor 122 is present, in a second implementation only the wireless transceiver 124 is present and in a third implementation both the temperature sensor 122 and the wireless transceiver 124 are present. The electronic device 112 is therefore not further described.

The cooking apparatus 710 has a double wall structure in that there are two walls, with each separated by a gap, except at coupled together end edges. The cooking apparatus 710 has a vessel 742 and a lid 740 dimensioned to fit an opening of the vessel 742. The electronic device 112 is shown to be mounted on the lid 740. However, in another implementation (not shown), the electronic device 112 can alternatively be mounted on the vessel 742. Other inserts of the cookware 700 include a tray 750, a rack 752 and a trivet 754. Unlike the vessel 742 and the lid 740, the tray 750, the rack 752 and the trivet 754 are not double wall structures.

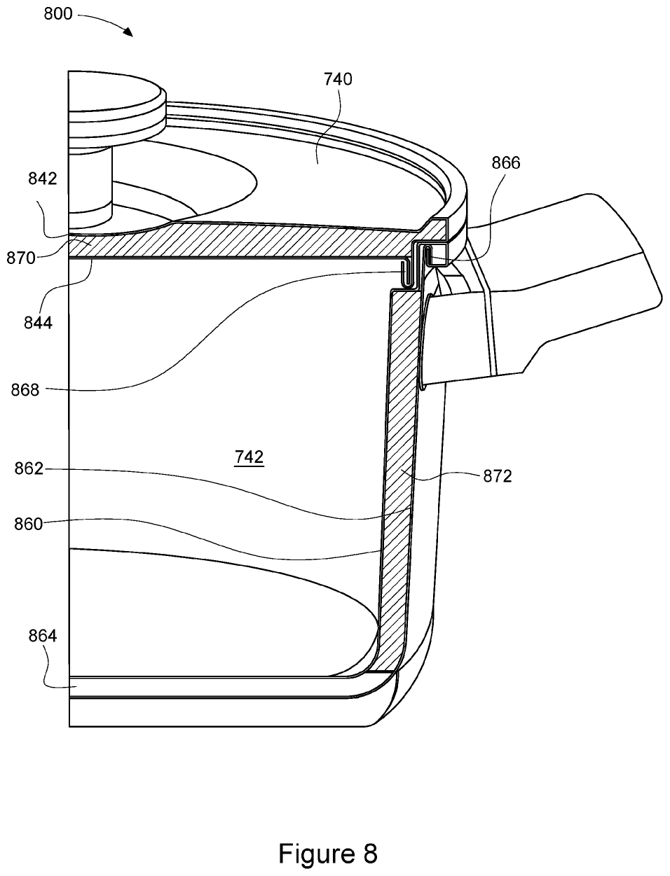

FIG. 8 shows a partial cross-sectional view of the vessel 742 with the lid 740. The vessel 742 has a heating base 864 from which an outer shell 862 and an inner shell 860 extend. The inner shell 860 surrounds a region for receiving content which is cooked by heat from the heating base 864. The lid 740 has an outer wall 842 and an inner wall 844, with the inner wall 844 facing the inner shell 860 of the vessel 742 when the lid 740 covers the vessel 742, as shown in FIG. 8.

Edges of the outer shell 862 and the inner shell 860 are welded or rolled to form a joint 866, while edges of the outer wall 842 and the inner wall 844 are welded or rolled together to form a joint 868. There is thus a sealed cavity 872 between the outer shell 862 and the inner shell 860 of the vessel 742 and a sealed cavity 870 between the outer wall 842 and the inner wall 844 of the lid 740. Both these cavities 870 and 872 may have heat insulator or have a vacuum to reduce heat loss and facilitate thermal cooking. The heat insulators may be in fluid form (such as one or more gases, a liquid, a mixture of gas and liquid); amorphous form; solid form; or a combination of one or more of these forms. Material such as silicone oil (liquid heat insulator) or high temperature ceramics (solid heat insulator) may be used. Another example has the cavity 872 between the outer shell 862 and the inner shell 860 being partially filled with heat insulating fluid and an air pocket.

In one embodiment, the cavities 870 and 872 are sealed from the outside. In another embodiment, a pressure valve (not shown) may be provided on the cooking apparatus 710 and operated to prevent build-up of pressure from steam generated from heating water that has seeped into the cavities 870 and 872. Such seepage may occur when the cooking apparatus 710 is washed if, for example, either or both of the weld at the joint 866 and weld at the joint 868 is defective. The pressure valve may be fixed, for example, to the outer shell 862 or under the handle of the lid 740.

The gap between the outer shell 862 and the inner shell 860 is approximately 5 to 20 mm Preferably, the outer shell 862, the inner shell 860, the outer wall 842 and the inner wall 844 are made of materials such as AISI304 stainless steel that has a thickness of about 0.5 to 1.0 mm. Alternatively, instead of using a single-layered stainless steel, a multiple-layered composite material may be used. Typically, two or more layered stainless steel or combination of stainless steel, aluminium or copper and steel are preferred.

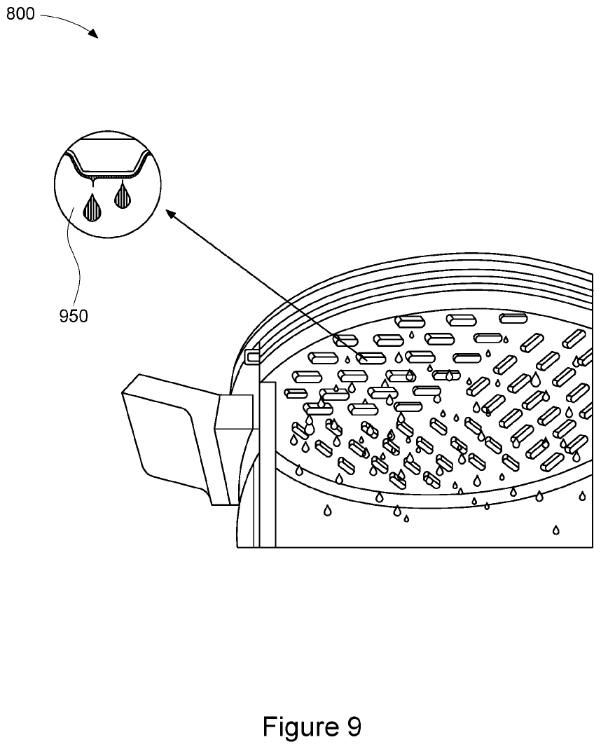

FIG. 9 shows a partial bottom view of the lid 740. The lid 740 is self-basting, with its inner wall 844 having a plurality of moisture catchment structures 950. These moisture catchment structures 950 circulate moisture and prevent meals from drying out.

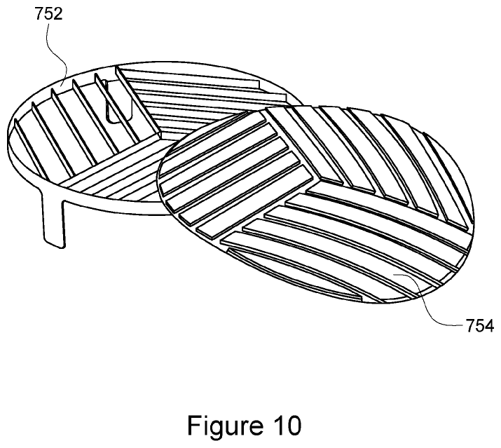

FIG. 10 shows a perspective view of the rack 752 and the trivet 754. The rack 752 is dimensioned to fit inside the vessel 742 and rest on the heating base 864. The rack 752 has grilles to allow heat and steam to pass through and evenly cook food that is placed onto the grilles. The trivet 754 is designed for use during the self-cooking mode 606 (see FIG. 6), for placement of the vessel 742 thereon. The trivet 754 is made from silicone and has a surface of raised protrusions that match the shape of the grilles of the rack 752. This facilitates storage of the trivet 754 with the rack 752.

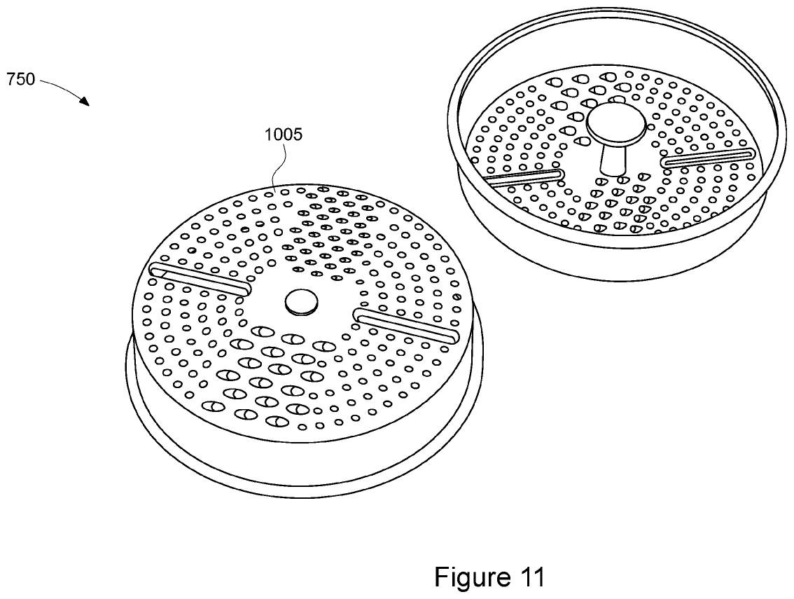

FIG. 11 shows top and bottom views of the tray 750. The tray 750 provides a steamer for vegetables. The tray 750 is dimensioned to fit inside the vessel 742 and has a base with a plurality of holes 1005. At least one of the holes 1005 has a periphery having at least a portion with a grating edge, which allows a user to slice and grate food directly into the vessel 742.

The above thus describes cookware having intelligent features which allows a cooking apparatus to continue cooking in a controlled manner without constant supervision. Ingredients are simply added in the cooking apparatus, a hob or stove turned on until the required temperature is reached, where the hob or stove is switched off and a user can walk away.

The intelligent features of the cookware come from its mounted electronic device that can communicate with an accompanying application that runs on a remote computing device. This intelligence senses when the cooking apparatus is ready to self-cook from quick cooking or a recipe selected from a library options. The cookware also allows entire meals to be cooked at once, through the use of inserts (see the tray 750 and the rack 752 of FIG. 7) that allow cooking meat and vegetables at the same time, while its double wall structure retains heat for hours.

With reference to FIGS. 2 to 4, the application 200 can be downloaded from storage in a non-transitory computer-readable medium of a server (not shown). This non-transitory computer-readable medium stores instructions that when executed by a processor of a computing device (such as a smart phone), cause the computing device to: receive a selected recipe from a database of stored recipes; determine a heating cooking duration and a thermal cooking duration for the selected recipe; and display a countdown for the heating cooking duration and the thermal cooking duration, wherein the countdown is initialised in response to receipt of an input (command) to commence cooking. By hosting the application 200 on the server, the application 200 can be continuously updated with patches that improve control of the electronic device 112 mounted in the cookware, along with new recipes.

In the application, unless specified otherwise, the terms “comprising”, “comprise”, and grammatical variants thereof, intended to represent “open” or “inclusive” language such that they include recited elements but also permit inclusion of additional, non-explicitly recited elements.

While this invention has been described with reference to exemplary embodiments, it will be understood by those skilled in the art that various changes can be made and equivalents may be substituted for elements thereof, without departing from the spirit and scope of the invention. In addition, modification may be made to adapt the teachings of the invention to particular situations and materials, without departing from the essential scope of the invention. Thus, the invention is not limited to the particular examples that are disclosed in this specification, but encompasses all embodiments falling within the scope of the appended claims

1. A cookware comprising:
a double wall cooking apparatus having a mounted electronic device, the mounted electronic device comprising:
a processor; and
an electronic display,
wherein the processor is programmed with instructions that, when executed, cause the processor at least to:
configure the electronic display to indicate a status of the double wall cooking apparatus.

2. The cookware of claim 1, wherein the mounted electronic device further comprises:
a temperature sensor calibrated to read an internal temperature of the double wall cooking apparatus,
wherein the configuration of the electronic display to indicate the status further comprises having the processor being programmed to:
obtain a reading from the temperature sensor, and
derive the status from the obtained reading.

3. The cookware of claim 1, wherein the electronic device further comprises:
a wireless transceiver,
wherein the configuration of the electronic display to indicate the status further comprises having the processor being programmed to:
detect receipt, by the wireless transceiver, of a command providing content for display by the electronic display; and
derive the status from the received command.

4. The cookware of claim 1, wherein the mounted electronic device further comprises:
a temperature sensor calibrated to read an internal temperature of the double wall cooking apparatus; and
a wireless transceiver,
wherein the configuration of the electronic display to indicate the status further comprises having the processor being programmed to:
obtain a reading from the temperature sensor;
detect receipt, by the wireless transceiver, of a command providing content for display by the electronic display; and
derive the status from the obtained reading and the received command.

5. The cookware of claim 3, wherein the processor is further programmed to synchronise the electronic display with a display of a remote computing device via the wireless transceiver communicating with the remote computing device.

6. The cookware of claim 1, wherein the status provides information on whether the double wall cooking apparatus is in one of: a dormant mode; a heating mode; a self-cooking mode; an alert mode; a feedback mode; a prompt mode or a complete mode.

7. The cookware of claim 6, wherein the processor is further programmed to configure the electronic display to:
display a heating cooking duration in the heating mode; and
display a self-cooking cooking duration in the self-cooking mode.

8. The cookware of claim 6, wherein the processor is further programmed to:
communicate, in the alert mode, a notification requiring acknowledgment; and
configure the electronic display to provide a sought input.

9. The cookware of claim 1, wherein the double wall cooking apparatus comprises:
a vessel having a heating base from which an outer shell and an inner shell extend; and
a lid comprising an outer wall and an inner wall, the lid being dimensioned to fit an opening of the vessel,
wherein the electronic device is mounted on either the vessel or the lid.

10. The cookware of claim 9, further comprising heat insulating material or a vacuum provided between the outer shell and the inner shell of the vessel and between the outer wall and the inner wall of the lid.

11. The cookware of claim 9, wherein the inner wall of the lid comprises a plurality of moisture catchment structures.

12. The cookware of claim 9, further comprising a tray dimensioned to fit inside the vessel, the tray having a base with a plurality of holes, wherein at least one of the holes has a periphery having at least a portion with a grating edge.

13. A cookware mounted electronic device comprising:
a processor; and
an electronic display,
wherein the processor is programmed with instructions that, when executed, cause the processor at least to:
configure the electronic display to indicate a status of a cooking apparatus to which the electronic device is mounted.

14. The cookware mounted electronic device of claim 13, further comprising:
a temperature sensor calibrated to read an internal temperature of the cooking apparatus,
wherein the configuration of the electronic display to indicate the status further comprises having the processor being programmed to:
obtain a reading from the temperature sensor, and
derive the status from the obtained reading.

15. The cookware mounted electronic device of claim 13, further comprising:
a wireless transceiver,
wherein the configuration of the electronic display to indicate the status further comprises having the processor being programmed to:
detect receipt, by the wireless transceiver, of a command providing content for display by the electronic display; and
derive the status from the received command.

16. The cookware mounted electronic device of claim 13, further comprising:
a temperature sensor calibrated to read an internal temperature of the cooking apparatus; and
a wireless transceiver,
wherein the configuration of the electronic display to indicate the status further comprises having the processor being programmed to:
obtain a reading from the temperature sensor;
detect receipt, by the wireless transceiver, of a command providing content for display by the electronic display; and
derive the status from the obtained reading and the received command.

17. The cookware mounted electronic device of claim 15, wherein the processor is further programmed to synchronise the electronic display with a display of a remote computing device via the wireless transceiver communicating with the remote computing device.

18. The cookware mounted electronic device of claim 17, wherein the processor is further programmed to have the wireless transceiver transmit identification data in response to receipt of a request, from the remote computing device, for presence of the electronic device.

19. The cookware mounted electronic device of claim 17, wherein the processor is further programmed to synchronise the electronic display with a display of the remote computing device via the wireless transceiver communicating with the remote computing device.

20. The cookware mounted electronic device of claim 13, wherein the status provides on whether the double wall cooking apparatus is in one of: a dormant mode; a heating mode; a self-cooking mode; an alert mode; a feedback mode; a prompt mode or a complete mode.

21. The cookware mounted electronic device of claim 20, wherein the processor is further programmed to configure the electronic display to:
display a heating cooking duration in the heating mode; and
display a self-cooking cooking duration in the self-cooking mode.

22. The cookware mounted electronic device of claim 20, wherein the processor is further programmed to:
communicate, in the alert mode, a notification requiring acknowledgment; and
configure the electronic display to provide a sought input.

23. A non-transitory computer-readable medium, with instructions stored thereon, which when executed by at least one processor of at least one computing device cause the at least one computing device to:
receive a selected recipe from a database of stored recipes;
determine a heating cooking duration and a self-cooking cooking duration for the selected recipe; and
display a countdown for the heating cooking duration and the self-cooking cooking duration,
wherein the countdown is initialised in response to receipt of an input to commence cooking.
